(19) United States
(12) Patent Application Publication
(10) Pub. No.: US 2025/0040576 A1
(43) Pub. Date: Feb. 6, 2025

(54) COLOR-ENHANCED BREADCRUMBS AND FROZEN FOOD INCLUDING SAME

(71) Applicant: CJ CHEILJEDANG CORPORATION, Seoul (KR)

(72) Inventors: Jung hwan KIM, Seoul (KR); Da Eun LEE, Seoul (KR); Eunyoung JOO, Seoul (KR); Minyeol LEE, Seoul (KR); Yuna KIM, Seoul (KR); Yunam CHA, Seoul (KR); Chul Jin KIM, Seoul (KR)

(73) Assignee: CJ CHEILJEDANG CORPORATION, Seoul (KR)

(21) Appl. No.: 18/714,505

(22) PCT Filed: Nov. 30, 2022
(86) PCT No.: PCT/KR2022/019171

§ 371 Date: May 29, 2024

(30) Foreign Application Priority Data
Nov. 30, 2021 (KR) 10-2021-0168973

(51) Int. Cl. A23L 7/157; A23L 5/43; A23L 13/00; A23L 13/40

(52) U.S. Cl. CPC A23L 7/157; A23L 5/43; A23L 13/03; A23L 13/428

(57) ABSTRACT

The present disclosure relates to a method for preparing bread crumbs, bread crumbs prepared thereby, and frozen foods prepared using the bread crumbs.

### TECHNICAL FIELD

The present disclosure relates to a method for preparing bread crumbs with improved color, bread crumbs prepared thereby, and frozen foods prepared using the bread crumbs.

### BACKGROUND ART

Bread crumbs are made by grinding wheat flour, etc. into particles, and include ingredients such as yeast, salt, and colorant, in addition to wheat flour. Bread crumbs are used as a coating on pork cutlets, croquettes, fried foods, etc. Additionally, bread crumbs are used to increase the adhesiveness of hamburger patties, etc., as a food extender for mixtures of various foods, animal feed, etc., and as a coating material of nuggets, etc. Further, they are used in large quantities in chicken nuggets, meat fillings, sausages, etc. In particular, the market for bread crumbs has grown significantly as they are used in large quantities in frozen foods.

However, the conventional manufacturing method of bread crumbs has a problem in that glucose, sugar, and an excessive amount of yeast must be used to create three-dimensional bread crumbs through short-term resting. In addition, the bread crumbs prepared by the above manufacturing method include glucose or sugar, etc., which causes a problem in that the color of the bread crumbs turns dark brown when heated once or twice (frying process), thereby deteriorating the quality. For example, in the case of frozen foods that are manufactured by applying bread crumbs and heating once during production, there is a problem that the color of the bread crumbs may become excessively dark when the consumer heats (reheats) the product for the second time using an air fryer, etc.

### PRIOR ART DOCUMENT

[Patent Document]

(Patent Document 1) Korean Patent No. 0432412

### Technical Problem

The present inventors have developed a method for preparing high-quality bread crumbs that maintains the color lightness of the bread crumbs even after heating once or twice, compared to the bread crumbs before heating, bread crumbs prepared by the above method, and frozen foods prepared using the bread crumbs, thereby completing the present disclosure.

### Technical Solution

It is one object of the present disclosure to provide a method for preparing bread crumbs, including the steps of:
preparing a primary dough by mixing the raw materials of the primary dough, which includes flour, yeast, and water;
subjecting the primary dough to the first resting for 12 to 30 hours;
preparing a secondary dough by mixing the raw materials of the secondary dough, which includes flour, salt, and water with the primary dough that has been subjected to the first resting;
subjecting the secondary dough to the second resting;
preparing bread by heating the secondary dough that has been subjected to the second resting; and
grinding the prepared bread.

It is another object of the present disclosure to provide bread crumbs prepared by the above method.

It is still another object of the present disclosure to provide bread crumbs including flour, yeast, salt, skim milk powder, colorant and water, wherein after heating once or twice, the color lightness (L value) of the bread crumbs decreases by 10% to 40% compared to the bread crumbs before heating.

It is yet another object of the present disclosure to provide frozen foods prepared using the bread crumbs.

### Advantageous Effects

High-quality bread crumbs that maintain the color lightness of the bread crumbs even after heating once or twice, compared to the bread crumbs before heating, may be prepared using the preparation method of the present disclosure.

### BRIEF DESCRIPTION OF DRAWINGS

FIG. 1 is a graph showing the specific volume of bread crumbs according to the flour ratio of the primary dough.

FIG. 2 is an image showing the degree of grinding of bread crumbs according to the flour ratio of the primary dough.

FIG. 3 is an image comparing bread for making bread crumbs according to the preparation method.

FIG. 4 is an image comparing the chromaticity of bread crumbs according to the preparation method and the amount of colorant added.

FIG. 5 is an image comparing the chromaticity of frozen foods according to the preparation method and the amount of colorant added.

### DETAILED DESCRIPTION OF PREFERRED EMBODIMENTS

The present disclosure will be described in detail as follows. Meanwhile, each description and embodiment disclosed herein can be applied to other descriptions and embodiments, respectively. That is, all combinations of various elements disclosed herein fall within the scope of the present disclosure. Further, the scope of the present disclosure is not limited by the specific description described below. A number of papers and patent documents have been cited throughout the present specification. The content of the cited papers and patent documents is incorporated herein by reference in their entirety, and the level of the technical field to which the present disclosure belongs and the contents of the present disclosure will be described more clearly.

One aspect of the present disclosure provides a method for preparing bread crumbs, including the steps of:
preparing a primary dough by mixing the raw materials of the primary dough, which includes flour, yeast, and water;
subjecting the primary dough to the first resting for 12 to 30 hours;
preparing a secondary dough by mixing the raw materials of the secondary dough, which includes flour, salt, and water with the primary dough that has been subjected to the first resting;
subjecting the secondary dough to the second resting;
preparing bread by heating the secondary dough that has been subjected to the second resting; and
grinding the prepared bread.

As used herein, the term “bread crumbs” refers to powder made by grinding bread, and may be wet bread crumbs. The wet bread crumbs may have a moisture content of 20% to 40%. It is important to prepare wet bread crumbs in a thin and long form to give a three-dimensional rich texture after frying the products to which the bread crumbs are applied.

Specifically, the method for preparing bread crumbs of the present disclosure will be described in detail.

First, a primary dough is prepared by mixing the raw materials of the primary dough.

As used herein, the term “yeast” includes both yeast and dry yeast.

In one embodiment of the present disclosure, the raw materials of the primary dough may include wheat flour (50 to 70%), yeast (specifically, 0.1 to 0.5% dry yeast), and water (50 to 60%), but are not limited thereto.

In one embodiment of the present disclosure, the dry yeast may be contained in an amount of 0.1 to 0.5 parts by weight based on 100 parts by weight of the total primary dough, but is not limited thereto. The above weight of the dry yeast is a suitable weight for the first resting period after the first kneading. If the weight exceeds the above range, the quality of the bread for making bread crumbs may not be suitable due to over-fermentation or insufficient fermentation during the first resting period.

In one embodiment of the present disclosure, the raw materials of the primary dough may additionally include yeast food, but are not limited thereto. The yeast food may include corn starch, refined salt, calcium sulfate, ammonium sulfate, ammonium chloride, or vitamin C, etc., and may promote fermentation by providing necessary nutrients to yeast and increase operational stability during baking.

In the present disclosure, as the raw materials of the primary dough, the known or commercially available products may be used, and are not limited to the specific types, names, ingredients, or manufacturing processes of each raw material.

Next, the primary dough is subjected to the first resting. The term “resting” includes a fermentation process of bread dough.

In one embodiment of the present disclosure, the first resting step may be performed in a temperature range of 15° C. to 45° C., specifically 20° C. to 35° C., and more specifically 20° C. to 30° C., for 12 to 30 hours, specifically for 12 to 25 hours, and more specifically for 14 to 18 hours, but is not limited thereto.

When the first resting step is performed at a temperature of less than 20° C., there is a problem that the resting may be slow and may not occur appropriately even when the dough is rested for a long time. When the first resting step is performed at a temperature exceeding 30° C., the dough is over-rested and may become watery when used as the main dough.

In the case of the above resting period, the resting period may be adjusted by the amount of dry yeast added, but is not limited thereto.

In one embodiment of the present disclosure, the raw materials of the primary dough and the raw materials of the secondary dough may not include glucose, sugar, fructose, or maltose, but are not limited thereto.

Specifically, the preparation method of the present disclosure may not include a step of separately adding glucose, sugar, fructose, and maltose to the primary dough and the secondary dough, but is not limited thereto.

Accordingly, the bread crumbs prepared by the preparation method of the present disclosure include a very small amount of glucose, fructose, and maltose in an amount of 0.05 to 0.3% by weight, which is the level of free sugars (glucose, fructose, and maltose) that naturally exist in flour.

In a general method for preparing bread crumbs, the glucose, sugar, fructose, and maltose facilitate the resting speed, so they are essential for producing three-dimensional bread crumbs through short-term resting. However, they are one of the causes of deteriorating quality as they are responsible for darkening the color of bread crumbs when heated at high temperatures.

The method for preparing bread crumbs of the present disclosure introduces the first resting step in which the resting is carried out with only damaged starch (at the level of 5 to 8%) generated during flour milling and a small amount of free sugars naturally occurring in flour, thereby producing high-quality bread crumbs that maintain the lightness of the color of the bread crumbs even after heating once or twice, compared to the bread crumbs before heating, while eliminating the step of separately adding glucose, sugar, fructose, and maltose.

Subsequently, a secondary dough is prepared by mixing the raw materials of the secondary dough with the primary dough that has been subjected to the first resting.

In one embodiment of the present disclosure, the raw materials of the secondary dough may additionally include skim milk powder and colorant, but are not limited thereto.

For example, the raw materials of the secondary dough may include wheat flour (30 to 50%), salt (0.5 to 2%), skim milk powder (1.0 to 3.0%), colorant (0.01 to 0.05%), and water, but are not limited thereto.

In one example of the present disclosure, the optimal content of the raw materials of the secondary dough was set. Specifically, when the flour is added in the above range, the volume of the bread for bread crumbs may be appropriately realized, and the internal characteristics may be improved. When the salt is added in the above range, the kneading properties may be improved, and the volume of the bread may be appropriately realized. When the shortening is added in the above range, the volume of bread for bread crumbs may be appropriately realized, and oil absorption property may be appropriate when frying wet bread crumbs. When the skim milk powder is added in the above range, the color of the fried food may be appropriately realized. When the colorant is added in the above range, the color of the fried food may be realized with appropriate lightness.

In one embodiment of the present disclosure, the skim milk powder and colorant may be contained in a mixing ratio of 200:1 to 10:1, for example, in a mixing ratio of 180:1, 15:1, 100:1, 90:1, 80:1, 70:1, 60:1, 50:1, 40:1, 30:1, 20:1, 15:1, and 10:1, but the mixing ratio is not limited thereto.

The weight of the skim milk powder and colorant may be appropriately realized when frying after preparation of wet bread crumbs, but if the weight is outside the range, the color of the fried food may be too dark or too yellow.

In one embodiment of the present disclosure, the raw materials of the secondary dough may additionally include shortening (1.0 to 3.0%), but are not limited thereto.

In one embodiment of the present disclosure, the colorant may be any one or more selected from the group consisting of annatto pigment, gardenia yellow pigment, safflower yellow pigment, turmeric pigment, Monascus yellow pigment, Beta-carotene, Monascus red pigment, gardenia red pigment, safflower red pigment, beet red, cochineal extract pigment, Lac pigment, Perilla pigment, red cabbage pigment, red radish color, purple sweet potato pigment, purple corn pigment, grape skin extract pigment, berry pigment, grape juice pigment, blue strawberry pigment, paprika extract pigment, gardenia blue pigment, spirulina pigment, chlorophyll pigment, cacao pigment, tamarind pigment, and kaoliang pigment, specifically annatto pigment, but is not limited thereto.

Specifically, the annatto pigment may be contained in an amount of 0.001% to 0.05% by weight, specifically 0.005% to 0.04% by weight, and more specifically 0.01% to 0.03% by weight based on the weight of flour, but is not limited thereto.

When the annatto pigment is contained in the above range, excellent sensory attributes may be realized, and a sufficient coloring effect suitable for use as a food ingredient may be exhibited.

In one embodiment of the present disclosure, in the step of preparing the secondary dough, the primary dough that has been subjected to the first resting and the secondary dough may be mixed at a mixing ratio of 4:6 to 8:2, specifically 5:5 to 7:3, and more specifically 6:4, but is not limited thereto.

When the primary dough is mixed at a mixing ratio of less than 4:6 based on the weight of flour, there is a problem in that the prepared bread may not realize the internal texture important for the formation of bread crumbs, which ultimately causes the bread crumbs to be grinded with a wider width. When the primary dough is mixed at a mixing ratio exceeding 8:2, there is a problem in that the specific volume of the prepared bread decreases, and thus decreasing the elasticity of the bread.

Subsequently, a step of preparing a dough shaped-body by shaping the prepared secondary dough may be additionally included, but is not limited thereto.

For example, the secondary dough may be divided into a predetermined amount to form a round or twist-shaped dough shaped-body. Specifically, the dough shaped-body may be formed by dividing the dough into units of 400 g to 600 g, but is not limited thereto.

Next, the secondary dough or the dough shaped-body is subjected to the second resting.

In one embodiment of the present disclosure, the second resting step may be performed in a temperature range of 20° C. to 40° C., specifically 25° C. to 40° C., and more specifically 35° C. to 40° C., for 30 minutes to 90 minutes, specifically for 35 to 70 minutes, and more specifically for 45 to 60 minutes, but is not limited thereto.

When the second resting is carried out under the above conditions, bread with a volume suitable for bread crumbs may be prepared, and the internal characteristics of the bread may be appropriately realized through suitable fermentation.

Specifically, the second resting step may be performed under humidity conditions of 75%, specifically 80%, and more specifically 85% or more, but is not limited thereto.

Under the above humidity conditions, the surface of the dough may not dry out, and the bread volume may be realized as desired.

Subsequently, bread is prepared by heating the secondary dough that has been subjected to the second resting or the dough shaped-body. The “heating” may include the process of baking the dough shaped-body.

In one embodiment of the present disclosure, the heating may be performed in a temperature range of 150° C. to 250° C., specifically 170° C. to 220° C., and more specifically 180° C. to 200° C., for 30 minutes to 90 minutes, specifically for 35 minutes to 70 minutes, and more specifically for 45 minutes to 60 minutes, but is not limited thereto.

Under the above temperature and time ranges, the bread may be properly baked, the crust may not be burned, and the bread may have an appropriate thickness, thereby increasing the yield of bread crumbs. Additionally, increasing the heating time may be a factor that hinders production efficiency.

Subsequently, a step of drying the prepared bread may be additionally included, but is not limited thereto.

In one embodiment of the present disclosure, the drying may be performed at room temperature for 18 hours to 30 hours, specifically for 20 hours to 25 hours, and more specifically for about 24 hours, but is not limited thereto.

When the drying time is carried out for the above time range, it may be easy to grind the bread crumbs into thin and long particles. If the drying time is increased, there is a problem that the production efficiency may be reduced.

Specifically, the prepared bread may be aged during the drying step.

Subsequently, the prepared bread is grinded.

In one embodiment of the present disclosure, the grinding may be grinding the prepared bread with a screen of 5 mm to 25 mm, specifically 7 mm to 20 mm, and more specifically 10 mm to 18 mm, but is not limited thereto.

When the prepared bread is grinded with a screen in the above range, the bread may be grinded to a size capable of producing wet bread crumbs, and the productivity may be increased as the bread effectively passes through the screen.

When the prepared bread is grinded with a screen less than 5 mm, it may not pass through the screen effectively, which may hinder productivity, and when the prepared bread is grinded with a screen exceeding 18 mm, there is a problem that the bread may be grinded to a size which makes it difficult to produce wet bread crumbs.

Specifically, the grinding step may include a step of sieving the grinded bread crumbs with a No. 5 mesh sieve, but is not limited thereto.

Another aspect of the present disclosure provides bread crumbs prepared by the above method.

In one embodiment of the present disclosure, after heating the bread crumbs once or twice, the color lightness (L value) of the bread crumbs may be reduced by 10% to 40%, specifically 15% to 35%, and more specifically 18% to 30%, compared to the bread crumbs before heating, but is not limited thereto.

In one embodiment of the present disclosure, the heating may be performed by a known frying process, for example, at a temperature of 160° C. to 190° C., and specifically 170° C. to 180° C., for 30 seconds to 5 minutes, specifically for 45 seconds to 3 minutes, and more specifically for 1 minute, but is not limited thereto.

In one embodiment of the present disclosure, the bread crumbs may have a color lightness (L value) of 50 to 60 after heating once or twice, but the color lightness is not limited thereto.

Therefore, since the bread crumbs of the present disclosure have the chromaticity above, they may be effectively used as high-quality bread crumbs with excellent sensory properties by maintaining the color lightness of the bread crumbs even after heating once or twice, compared to the bread crumbs before heating.

In one embodiment of the present disclosure, the bread crumbs may have increased color lightness (L value) after heating once or twice, compared to bread crumbs prepared by a preparation method that does not include the first resting step, but are not limited thereto.

Specifically, the bread crumbs of the present disclosure may have reduced color lightness (L value) before heating, compared to bread crumbs prepared by a preparation method that does not include the first resting step.

Meanwhile, the conventional method of preparing bread crumbs that does not include the first resting step has the problem of having to use glucose, sugar, and an excessive amount of yeast in order to create three-dimensional bread crumbs through short-term resting. Since, bread crumbs prepared by the above method contain glucose or sugar, the color of the bread crumbs turns dark brown when heated once or twice, thereby deteriorating the quality. In contrast, the bread crumbs of the present disclosure are prepared by the method which does not separately add glucose, sugar, fructose, and maltose, and thus, the color lightness (L value) after heating once or twice is increased compared to bread crumbs prepared by the preparation method that does not include the first resting step. Therefore, the bread crumbs of the present disclosure may be effectively used as high-quality bread crumbs that maintain the color lightness of the bread crumbs even after heating once or twice, compared to the bread crumbs before heating.

In one embodiment of the present disclosure, the bread crumbs may be bread crumbs for frozen foods, but are not limited thereto.

The bread crumbs for frozen foods can maintain the color lightness of the bread crumbs even after heating once or twice, compared to the bread crumbs before heating, and accordingly, the lightness of the color of the frozen foods may be maintained as they adhere to the surface of frozen foods requiring additional heating, compared to the frozen foods before heating.

Still another aspect of the present disclosure provides bread crumbs including flour, yeast, salt, skim milk powder, colorant and water, wherein after heating once or twice, the color lightness (L value) of the bread crumbs decreases by 10% to 40% compared to the bread crumbs before heating.

In one embodiment of the present disclosure, the heating may be performed by a known frying process, for example, at a temperature of 160° C. to 190° C., and specifically 170° C. to 180° C., for 30 seconds to 5 minutes, specifically for 45 seconds to 3 minutes, and more specifically for 1 minute, but is not limited thereto.

In one embodiment of the present disclosure, the bread crumbs may have a color lightness (L value) of 50 to 60 after heating once or twice, but the color lightness is not limited thereto.

Therefore, since the bread crumbs of the present disclosure have the chromaticity above, they may be effectively used as high-quality bread crumbs with excellent sensory properties by maintaining the color lightness of the bread crumbs even after heating once or twice, compared to the bread crumbs before heating.

Yet another aspect of the present disclosure provides frozen foods prepared using the bread crumbs above.

As used herein, the term “frozen food” refers to manufactured, processed or cooked food, which is frozen or stored for the purpose of long-term preservation, and may include all frozen foods known in the art, and is not limited thereto, as long as they can be coated with the bread crumbs.

Specific examples of the frozen foods include, but are not limited to, frozen pork cutlet, frozen croquette, frozen chicken nugget, frozen cheese bite, frozen fish finger, frozen croquette, frozen pork cutlet, frozen fried shrimp, and other frozen fried food.

Meanwhile, frozen foods are generally frozen after primary cooking, and are prepared through a secondary cooking process once they reach consumers. Accordingly, in the case of frozen foods coated with bread crumbs, there is a problem in that the color of the bread crumbs on the surface turns dark brown after the second heating, and thus deteriorating the quality.

The frozen food of the present disclosure has the advantage of increasing preference and aesthetics using high-quality bread crumbs that maintain the color lightness of the bread crumbs even after heating once or twice, compared to the bread crumbs before heating.

In one embodiment of the present disclosure, the frozen food may have increased color lightness (L value) after heating once or twice, compared to frozen food prepared using the bread crumbs prepared by a preparation method that does not include the first resting step, but is not limited thereto.

In one embodiment of the present disclosure, the frozen food may have a color lightness (L value) value of 43 to 60 after heating once or twice, but is not limited thereto.

In one embodiment of the present disclosure, the frozen food is not limited to, but may be frozen food for a microwave or air fryer, and specifically, frozen food for an air fryer.

### MODE FOR CARRYING OUT THE INVENTION

Hereinafter, the present disclosure will be described in detail by way of Examples. However, these Examples are merely preferred Examples given for illustrative purposes, and thus, the scope of the present disclosure is not intended to be limited to or by these Examples. Meanwhile, technical features which are not described herein can be sufficiently understood and easily carried out by those skilled in the art in the technical field of the present disclosure or in a similar technical field.

### Example 1. Preparation of Bread Crumbs

### Example 1-1. Preparation of Bread for Making Bread Crumbs

### (1) Preparation of Primary Dough and First Resting

600 g of flour (CJ CheilJedang), 6 g of yeast food (Jenico Foods), 3 g of instant dry yeast (Jenico Foods), and 500 g of water were added to a dough mixer (Hobart, HL200) to prepare a primary dough. Subsequently, the primary dough was rested for 14 to 18 hours in a fermenter at 20 to 30° C. (Daeyung Bakery Machinery co., Ltd., MPO-2002).

### (2) Preparation of Secondary Dough (Main Dough)

400 g of flour (CJ CheilJedang), 3 g of salt (Hanju Salt), 20 g of palm shortening (Samyang Corporation), 10 g of skim milk powder (Seoul Milk), and 10 g of water were added to the rested dough in (1) above, and annatto pigment was added thereto in respective amounts of 0.1 g, 0.2 g, and 0.3 g based on the total weight of flour (based on the flour of the primary and secondary doughs), and then the mixture was added to a dough mixer (Daeyung Bakery Machinery co., Ltd., MPO-2002), and kneaded. The bread crumbs to which 0.1 g, 0.2 g, or 0.3 g of annatto pigment were added were named annatto pigment 0.01%, annatto pigment 0.02%, and annatto pigment 0.03%, respectively.

### (3) Dividing and Panning

The kneaded dough of (2) above was divided into units of 400 to 600 g and elastically shaped into thin and long lumps, and the two lumps of dough were twisted together in the form of a twist and placed in a bread mold (bread pan).

### (4) Second Resting

The dough, which was formed and placed in the bread mold in (3) above, was rested for 45 to 60 minutes in a proofer machine (Daeyung Bakery Machinery co., Ltd., MPO-2002) at 35 to 40° C. with humidity of 85% or more.

### (5) Heating, Cooling, and Aging

The dough in the bread mold rested in (4) above was heated at about 180 to 200° C. for 40 to 60 minutes, and then the heated bread was cooled and aged at room temperature for 24 hours.

### Example 1-2. Preparation of Bread Crumbs

### (6) Grinding

The dried bread of (5) of Example 1-1 was grinded with a screen of 10 to 18 mm using a bread crumb grinder (Youngsong Machinery), and then sieved through a No. 5 mesh sieve to prepare bread crumbs from which small particles were removed.

### Example 2. Preparation of Frozen Foods

Frozen foods (pork cutlets) were prepared using the bread crumbs prepared in Example 1. Specifically, the batter mix for making pork cutlet shown in Table 1 below was used as pre-dust and liquid batter for adhering breadcrumbs.

TABLE 1

| Raw Material | Mixing Ratio (%) |
|---|---|
| Flour | 45~55 |
| Starch | 30~40 |
| Glucose | 1~5 |
| Modified starch | 1~5 |
| Processed starch | 1~5 |
| product | |
| Calcium carbonate | 1~5 |
| Baking powder | 0.1~2.0 |
| Gums | 0.01~0.2 |
| Total | 100 |

Pork loin for making pork cutlets coated with pre-dust was added to the batter liquid, in which 200 to 250 g of water was mixed with 100 g of the batter mix in Table 1, and coated with the batter liquid.

Subsequently, the wet breadcrumbs prepared in Example 1 were evenly pressed and applied, and then first fried for 3.5 to 5.5 minutes in a fryer (Rinnai RFA-227E) preheated to 180° C. (first frying).

Subsequently, the cooked pork cutlet was rapidly frozen at −35° C. for 1 hour (product temperature −10° C. or lower) in a quick freezer (PANEM RXP4-D) to prepare frozen food.

### Comparative Example 1. Preparation of Bread Crumbs Using Straight-Dough Method

### Comparative Example 1-1. Preparation of Bread for Making Bread Crumbs

### (1) Preparation of Dough

1000 g of flour (CJ CheilJedang), 5 to 20 g of salt (Hanju Salt), 10 to 30 g of palm shortening (Samyang Corporation), 5 to 7 g of yeast food (Jenico Foods), 10 to 20 g of instant dry yeast (Jenico Foods), and 600 to 700 g of water were added to a dough mixer (Daeyung Bakery Machinery co., Ltd., MPO-2002) and kneaded.

### (2) First Resting

The kneaded dough of (1) above was rested in a fermenter (Daeyung Bakery Machinery co., Ltd., MPO-2002) at 25 to 30° C. with humidity of 75 to 85% for 60 to 90 minutes.

### (3) Dividing and Panning

The kneaded dough of (2) above was divided into units of 400 to 600 g and elastically shaped into thin and long lumps, and the two lumps of dough were twisted together in the form of a twist and placed in a bread mold (bread pan).

### (4) Second Resting

The dough, which was formed and placed in the bread mold in (3) above, was rested for 45 to 60 minutes in a fermenter (Daeyung Bakery Machinery co., Ltd., MPO-2002) at 35 to 40° C. with humidity of 85% or more.

### (5) Heating, Cooling and Aging

The dough in the bread mold rested in (4) above was heated at about 180 to 200° C. for 40 to 60 minutes, and then the heated bread was cooled and aged at room temperature for 24 hours.

### Comparative Example 1-2. Preparation of Bread Crumbs

### (6) Grinding

The dried bread of (5) of Comparative Example 1-1 was grinded with a screen of 10 to 18 mm using a bread crumb grinder (Youngsong Machinery), and then sieved through a No. 5 mesh sieve to prepare final bread crumbs from which small particles were removed.

### Comparative Example 2. Preparation of Frozen Foods Using Bread Crumbs Prepared by Straight-Dough Method

Frozen foods were prepared in the same manner as in Example 2, except that the bread crumbs prepared in Comparative Example 1 were used.

### Experimental Example 1. Measurement of Specific Volume of Bread According to Flour Ratio of Primary and Secondary Doughs and Observation of Shape of Bread Crumbs

In order to confirm the effect of the ratio of flour of the primary and secondary doughs, bread for making bread crumbs was prepared by varying the ratios of the flour of the doughs according to the method of Example 1 above, and each bread was grinded to prepare bread crumbs and the shape was observed.

Specifically, based on 100% of the total flour included in the primary and secondary doughs, the ratio of flour of the primary dough was adjusted to 40 to 80%. Accordingly, the ratio of flour of the secondary dough was adjusted to 60 to 20%.

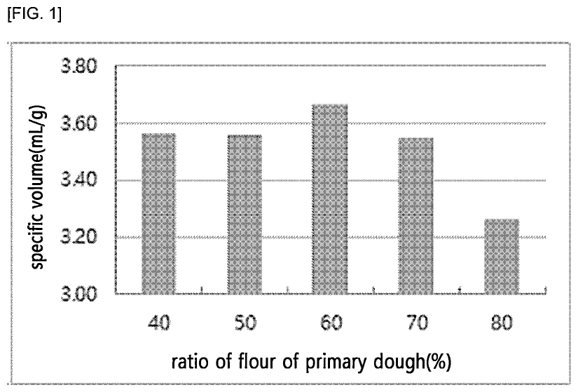

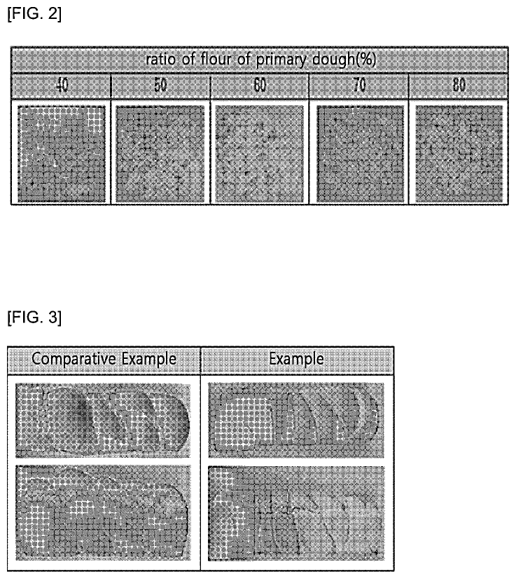

By adjusting each ratio, i) the specific volume was measured 24 hours after preparing bread (Table 2 and FIG. 1), and ii) the degree of grinding of the bread crumbs was visually compared (FIG. 2).

TABLE 2

| Ratio of Flour | | | Specific |
|---|---|---|---|
| of Primary | Mass | Volume | Volume |
| Dough (%) | (g) | (mL) | (mL/g) |
| 40 | 850 | 3028 | 3.56 |
| 50 | 842 | 2995 | 3.56 |
| 60 | 836 | 3065 | 3.67 |
| 70 | 838 | 2972 | 3.55 |
| 80 | 845 | 2755 | 3.26 |

As a result, it was confirmed that when the ratio of flour of the primary dough was 80%, the specific volume of the prepared bread decreased by 12.5% compared to the bread whose ratio of flour of the primary dough was 60% (Table 2 and FIG. 1). Additionally, it was confirmed that when the ratio of flour of the primary dough was 40%, the internal texture of the bread, which is important for the quality of bread crumbs, was not sufficiently realized when the prepared bread was pulled apart. Accordingly, when preparing bread crumbs using such bread, the bread crumbs were grinded with a wider width (FIG. 2).

### Experimental Example 2. Measurement of Physical Properties of Bread Crumbs According to Preparation Methods

The physical properties of the bread crumbs prepared in Example 1 and the bread crumbs prepared in Comparative Example 1 were compared using a Texture Analyzer (TA) (Stable Micro Systems, TA-XT plus). TA analysis conditions are shown in Table 3 below.

TABLE 3

| Test | Bulk compression Test | |
|---|---|---|
| Probe type | Cylinder (p/25) | |
| Probe D | 2.5 | cm |
| load cell | 50 | kg |
| Trigger force | 0.050N | |
| Distance | 10.5 | mm |
| Sample amount | 3 | g |
| Sample loading | 1.5 | cm |
| height | | |

The sample preparation conditions for the TA analysis are as follows:

15 g of bread crumbs were measured, placed in a frying net, fried in soybean oil for 1 minute in a fryer preheated to 180° C., cooled for 5 minutes, and then placed in an acrylic cylinder with a diameter of 30 mm and a height of 20 mm for analysis.

TABLE 4

| Category | Force | Count Peaks |
|---|---|---|
| Comparative | 2110.5 ± 375.4 | 81.6 ± 3.7 |
| Example 1 | | |
| Example 1 | 2396.7 ± 133.8 | 91.6 ± 4.4 |

As a result, as shown in Table 4, it was confirmed that the force value of the bread crumbs prepared in Example 1 was about 13.5% higher than that of Comparative Example 1, and the count peak value of the bread crumbs prepared in Example 1 was about 10.9% higher than that of Comparative Example 1.

The count peak value is the number of times the force (degree of breakage) exceeds the threshold of 0.049 N during the process of extruding fried food by a probe. As the count peak value increases, the number of breakages increases, confirming that the crispiness increases relatively.

Accordingly, the bread crumbs prepared in Example 1 had higher force and count peak values, confirming that they were crispier than those in Comparative Example 1.

### Experimental Example 3. Measurement of Chromaticity of Bread Crumbs According to Preparation Method and Amount of Colorant Added

The chromaticity of the bread crumbs prepared in Example 1 and the bread crumbs prepared in Comparative Example 1 before and after heating (frying) was compared.

Specifically, in order to measure chromaticity (L, a, b) using a spectrophotometer (KONICA MINOLTA, Spectrophotometer CM-5), 15 g of bread crumbs were measured, placed in a frying net, fried in soybean oil for 1 minute in a fryer preheated to 180° C., cooled for 5 minutes, and then placed in an acrylic cylinder with a diameter of 45 mm and a height of 15 mm for analysis.

TABLE 5

| | | Before heating | | | After heating | | |
|---|---|---|---|---|---|---|---|
| Category | | L | a | b | L | a | b |
| Comparative Example 1 | | 80.04 ± 1.68 | 0.11 ± 0.14 | 17.17 ± 0.2 | 44.06 ± 0.77 | 14.07 ± 0.12 | 24.67 ± 0.35 |
| Example | Annatto | 76.02 ± 0.1 | 4.74 ± 0.15 | 23.14 ± 0.33 | 53.52 ± 0.39 | 12.65 ± 0.06 | 31.41 ± 0.04 |
| 1 | pigment | | | | | | |
| | 0.01% | | | | | | |
| | Annatto | 73.12 ± 0.12 | 7.13 ± 0.01 | 25.94 ± 0.11 | 54.33 ± 0.84 | 13.11 ± 0.04 | 32.54 ± 0.44 |
| | pigment | | | | | | |
| | 0.02% | | | | | | |
| | Annatto | 71.7 ± 0.46 | 10.62 ± 0.09 | 31.47 ± 0.12 | 58.45 ± 0.3 | 10.53 ± 0.26 | 32.55 ± 0.41 |
| | pigment | | | | | | |
| | 0.03% | | | | | | |

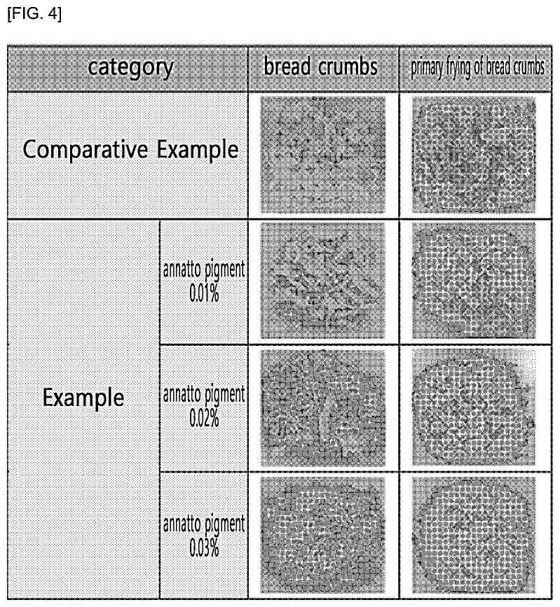

As a result, as shown in Table 5 and FIG. 4, the bread crumbs prepared in Comparative Example 1 showed a significant and rapid change in chromaticity, with a decrease in lightness (L value) after frying, compared to the bread crumbs prepared in Example 1.

Specifically, it was confirmed that the bread crumbs prepared in Comparative Example 1 had a decrease in color lightness (L value) by about 44.95% after heating, compared to the bread crumbs before heating. In contrast, it was confirmed that the bread crumbs prepared in Example 1 after heating had a decrease in color lightness (L value) by about 29.6%, about 25.7%, and about 18.48%, respectively, depending on the amount of annatto pigment added, compared to the bread crumbs before heating, confirming that the change in chromaticity due to heating was insignificant.

Additionally, it was confirmed that the bread crumbs prepared in Example 1 had a color lightness (L value) of 50 to 60 after heating. To this end, the bread crumbs prepared in Example 1 showed a lower lightness (L value) before heating, compared to the bread crumbs prepared in Comparative Example 1, while showing a higher lightness of the bread crumbs after heating, thus confirming that the color after heating was lighter than that of the conventional bread crumbs.

Further, in the case of the bread crumbs prepared in Example 1, it was confirmed that as the amount of annatto pigment added increased, the lightness (L value) of the bread crumbs before heating decreased, while the lightness (L value) of the bread crumbs after heating increased as the amount of annatto pigment added increased.

### Experimental Example 4. Measurement of Chromaticity of Frozen Foods According to Preparation Method and Amount of Colorant Added

The chromaticity of the frozen pork cutlets prepared in Example 2 and the frozen pork cutlets prepared in Comparative Example 2 before and after heating (frying) was compared.

Specifically, the chromaticity (L, a, b) was measured using a spectrophotometer (KONICA MINOLTA, Spectrophotometer CM-5) by heating the pork cutlet, cooling it for 5 minutes, and then placing the sample of the pork cutlet itself on the analyzer. Secondary heating is a second frying/heating process for eating the frozen pork cutlets that had been primarily fried in the preparation process of Example 2 and Comparative Example 2. More specifically, the frozen pork cutlet was secondarily heated (reheated) for 15 minutes in an air fryer (Philips HD9220) preheated to 180° C.

TABLE 6

| | | Primary Heating of Pork Cutlets | | | Secondary Heating of Pork Cutlets | | |
|---|---|---|---|---|---|---|---|
| | | (Frying) | | | (in Air Fryer) | | |
| Category | | L | a | b | L | a | b |
| Comparative Example 2 | | 41.65 ± 1.09 | 16.84 ± 0.37 | 28.69 ± 0.85 | 38.79 ± 0.5 | 16.7 ± 0.34 | 28.18 ± 0.33 |
| Example | Annatto | 50.36 ± 1.48 | 14.93 ± 0.23 | 33.48 ± 1.02 | 46.32 ± 0.92 | 15.03 ± 0.74 | 29.25 ± 1.36 |
| 2 | pigment | | | | | | |
| | 0.01% | | | | | | |
| | Annatto | 53.65 ± 0.27 | 15.01 ± 0.26 | 35.99 ± 1.28 | 49.45 ± 1.35 | 15.9 ± 0.51 | 34.04 ± 0.58 |
| | pigment | | | | | | |
| | 0.02% | | | | | | |
| | Annatto | 54.62 ± 0.61 | 13.88 ± 0.32 | 35.3 ± 0.56 | 50.93 ± 1.06 | 14.96 ± 0.16 | 33.07 ± 0.54 |
| | pigment | | | | | | |
| | 0.03% | | | | | | |

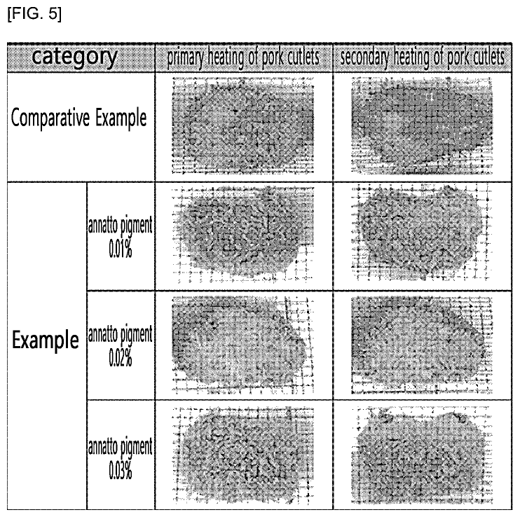

As a result, as shown in Table 6 and FIG. 5, the lightness (L value) of the frozen pork cutlets prepared in Example 2 after the primary heating and the secondary heating was higher compared to the frozen pork cutlets prepared in Comparative Example 2 by 17.3% to 23.8% and 16.3% to 23.8%, respectively. In addition, it was confirmed that the frozen pork cutlets prepared in Example 2 had a color lightness (L value) value of 43 to 60 after heating.

Additionally, in the case of the frozen pork cutlets prepared in Example 2, it was confirmed that the lightness (L value) after the primary heating and the secondary heating increased as the amount of annatto pigment added increased.

### Experimental Example 5. Sensory Evaluation of Bread Crumbs and Frozen Foods According to Preparation Method

Sensory evaluation of bread crumbs and frozen foods was conducted using the frozen food (pork cutlets) prepared in Example 2 (annatto pigment 0.02%) and the frozen food (pork cutlets) prepared in Comparative Example 2.

Specifically, the frozen pork cutlets were secondarily heated (reheated) for 15 minutes in an air fryer (Philips HD9220) preheated to 180° C. The reheated pork cutlet was cut to a width of 20 mm and provided piece by piece, and a sensory evaluation was conducted on 30 trained panelists.

TABLE 7

| | | | Preference | | | | | |
|---|---|---|---|---|---|---|---|---|
| | | | of | | | | | |
| | | Preference of | Crunchiness | | | | | |
| | | Adhesiveness | of | | | | Off- | |
| | Color | of Bread | Bread | | Crispiness | Taste | smell, | Overall |
| Category | Preference | Crumbs | Crumbs | Crispiness | Preference | Preference | Off-taste | Preference |
| Comparative | 3.05 | 3.68 | 3.27 | 4.02 | 3.85 | 3.65 | 2.10 | 3.35 |
| Example | | | | | | | | |
| 1 | | | | | | | | |
| Example 1 | 4.35 | 4.35 | 4.42 | 4.38 | 4.35 | 4.20 | 1.77 | 4.48 |
| p-value | 0.0000 | 0.0047 | 0.0000 | 0.0770 | 0.0268 | 0.0144 | 0.2382 | 0.0000 |

As a result, as shown in Table 7, it was confirmed that the bread crumbs prepared in Example 1 adhered to Example 2 showed a higher preference for color, adhesiveness, crunchiness, crispiness, taste, flavor, etc., than the bread crumbs prepared in Comparative Example 1 adhered to Comparative Example 2.

From the foregoing, a skilled person in the art to which the present disclosure pertains will be able to understand that the present disclosure may be embodied in other specific forms without modifying the technical concepts or essential characteristics of the present disclosure. In this regard, the exemplary embodiments disclosed herein are only for illustrative purposes and should not be construed as limiting the scope of the present disclosure. On the contrary, the present disclosure is intended to cover not only the exemplary embodiments but also various alternatives, modifications, equivalents, and other embodiments that may be included within the spirit and scope of the present disclosure as defined by the appended claims.

1. A method for preparing bread crumbs, comprising the steps of:
preparing a primary dough by mixing the raw materials of the primary dough, which comprises flour, yeast, and water;
subjecting the primary dough to the first resting for 12 to 30 hours;
preparing a secondary dough by mixing the raw materials of the secondary dough, which comprises flour, salt, and water with the primary dough that has been subjected to the first resting;
subjecting the secondary dough to the second resting;
preparing bread by heating the secondary dough that has been subjected to the second resting; and
grinding the prepared bread.

2. The method of claim 1, wherein the first resting is performed in a temperature range of 20° C. to 30° C.

3. The method of claim 1, wherein the raw material of the secondary dough further comprises skim milk powder and colorant.

4. The method of claim 1, wherein in the step of preparing the secondary dough, the flour of the rested primary dough and the secondary dough are mixed at a mixing ratio of 4:6 to 8:2.

5. The method of claim 1, wherein the produced bread is grinded with a screen of 5 mm to 25 mm.

6. The method of claim 1, wherein the yeast is comprised in an amount of 0.1 to 0.5 parts by weight based on 100 parts by weight of the total primary dough.

7. The method of claim 3, wherein the skim milk powder and colorant are comprised in a mixing ratio of 200:1 to 10:1.

8. The method of claim 1, wherein the raw materials of the primary dough and the raw materials of the secondary dough do not comprise glucose, sugar, fructose, or maltose.

9. Bread crumbs prepared by the method of claim 1.

10. The bread crumbs of claim 9, wherein after heating the bread crumbs once or twice, the color lightness (L value) of the bread crumbs decreases by 10% to 40% compared to the bread crumbs before heating.

11. The bread crumbs of claim 10, wherein the heating is performed at a temperature of 160° C. to 190° C. for 30 seconds to 5 minutes.

12. The bread crumbs of claim 9, wherein the bread crumbs have a color lightness (L value) of 50 to 60 after heating once or twice.

13. Bread crumbs comprising flour, yeast, salt, skim milk powder, colorant and water, wherein after heating once or twice, the color lightness (L value) of the bread crumbs decreases by 10% to 40% compared to the bread crumbs before heating.

14. The bread crumbs of claim 13, wherein the heating is performed at a temperature of 160° C. to 190° C. for 30 seconds to 5 minutes.

15. The bread crumbs of claim 13, wherein the bread crumbs have a color lightness (L value) of 50 to 60 after heating once or twice.

16. A frozen food, comprising the bread crumbs of claim 9.

17. The frozen food of claim 16, wherein the frozen food has a color lightness (L value) of 50 to 60 after heating once or twice.
